(19) United States
(12) Patent Application Publication
(10) Pub. No.: US 2018/0206408 A1
(43) Pub. Date: Jul. 26, 2018

(54) CHOPPING DRUM FOR A FORAGE HARVESTER

(71) Applicant: Deere & Company, Moline, IL (US)

(72) Inventors: Matthias Stein, Homburg (DE); Johannes Linde, Jena (DE)

(21) Appl. No.: 15/872,054

(22) Filed: Jan. 16, 2018

(30) Foreign Application Priority Data
Jan. 25, 2017 (DE) 102017201160.2

(51) Int. Cl. A01F 29/09; A01D 87/00; A01F 29/06

(52) U.S. Cl. CPC A01F 29/095; A01F 29/06; A01D 87/0007

(57) ABSTRACT

A chopping drum is provided for a forage harvester including a plurality of blade holders distributed around the periphery of the chopping drum, and a plurality of chopping blades. Each of the chopping blades is selectively coupled to at least one blade holder in one of at least two different positions specified by a form-fitting means.

### RELATED APPLICATIONS

This application claims priority to German Patent Application Ser. No. 102017201160.2, filed Jan. 25, 2017, the disclosure of which is hereby expressly incorporated by reference in its entirety.

### FIELD OF THE DISCLOSURE

The present disclosure relates to a forage harvester, and in particular, to a forage harvester with a chopping drum having a plurality of blade holders distributed around the periphery of the drum to each of which a chopping blade is fixed.

### BACKGROUND

Forage harvesters are used to pick up plants or the crop-bearing parts thereof and cut them into small pieces. The plants on the field are usually cut off from the roots, which remain in the ground, by a suitable harvesting header and fed to an intake channel of the forage harvester. Alternatively, the plants can be cut off and deposited as swaths in a preceding work step and picked up by means of a pick-up, or only the crop-bearing parts are separated from the plants and conveyed into the intake channel. In the intake channel, the mat of crop is pre-compressed by cooperating pressing rollers under a preload one against another, which feed the crop mat to a chopping drum, about the circumference (and optionally the width) of which a number of chopping blades are distributed. The chopping blades, in cooperation with counter-blades, cut the crop into small pieces. The cut-up crop (and particularly the grains of corn contained therein) is optionally cut up further by a post-processing unit, conveyed by a post-accelerator into an ejection chute and loaded onto a transport vehicle. The chopped crop material is used particularly as food for animals or for producing biogas.

The chopping drum can be designed as a contiguous surface or as an open supporting structure. The chopping drum holds a number of blade holders, onto which the individual chopping blades are bolted.

During cutting of the crop, the distance between the cutting edge of the blade and the counter blade, in addition to the sharpness of the blades, is very important for achieving a good cutting result in an energy-saving manner. For this purpose, the chopping blades are subjected during the initial assembly process, and from time to time thereafter, to a sharpening process in which a whetstone interacts with the rotating chopping drum. It is then guaranteed that all cutting edges are sharp and that there is a sufficiently equal distance from the axis of rotation of the chopping drum.

During the harvesting process and the sharpening, the chopping blades become increasingly shorter, which leads to the necessity to replace them from time to time. In addition, a change in the type of plant material to be harvested (e.g., grass or corn) can require a change of chopping blades adapted to the type of crop. Individual chopping blades can also be damaged during operation and require replacement.

When it is time to re-equip a chopping drum with chopping blades, care must be taken that, to the greatest extent possible, all chopping blades are attached in the same position, i.e., no chopping blades protrude past others or are offset inward in relation to others. Compensating for such differences is time-intensive and requires expensive loss of material due to grinding the chopping blades. The same applies to the case where an individual chopping blade has to be replaced. Equipping the chopping drum with chopping blades thus requires precise positioning of the chopping blades, for which users rely on a visual inspection or use a gauge that cooperates with a reference point on the frame of the forage harvester and subsequently bolt the chopping blades tightly in place. But since the position of the chopping blade still changes during tightening the bolts, this process must sometimes be carried out several times until the positions of the chopping blades are adjusted with sufficient precision. Installing the chopping blades is accordingly very time-intensive.

If an assistance tool is used (such as disclosed in EP 2 386 200 A1), the necessity for readjusting the blades can be eliminated because they have already been adjusted under a high preload and thus slipping of the blades when tightening the bolts is less possible. Nevertheless, the resulting gap must still be checked visually by the installer.

To simplify the positioning of the chopping blades during installation, it has been proposed (e.g., DE 70 38 523 U1, DE 1 279 415 A) to attach adjusting bolts in contact with the rear sides of the chopping blades to the blade holders. The chopping blades can thus be loosely pre-installed and brought by means of the adjusting bolt into a suitable position before they are finally bolted tight. There is still the problem here, however, that the adjusting bolts must be brought into the suitable position, and therefore the equipping process is not substantially sped up.

In addition, EP 1 110 446 A1 proposes to mount shell-shaped curved chopping blades form-fittingly on the blade holder in order to avoid through holes in the shell-shaped chopping blades, which have a weakening effect, as well as bolt heads protruding into the shell formed by the chopping blade and negatively affecting the flow of chopped material. For this purpose, the chopping blades are pressed on the rear side against the blade holder by means of a bolt and a cone and coupled in the front region to the blade holder by means of a protrusion or a locating pin. This arrangement ensures that all chopping blades automatically assume the same position, because maladjustment is not possible due to the form-fitting attachment on the blade holder. However, there is a disadvantage that, in case of replacement of a chopping blade, the new chopping blade must be ground off by means of the sharpening device for the forage harvester or some other grinding device sufficiently that the envelope circle thereof coincides with that of the other chopping blades, which have generally already been worn down. This process is time-intensive, reduces the service life of the new blades and wears out the whetstone. Another disadvantage is that the chopping blades are not capable of yielding contrary to the rotational direction in the event of an overload, (e.g., when a foreign body is picked up). The chopping blades also cannot be pulled forward after a certain amount of wear and fixed again in that position in order to improve the air-conveying effect of the chopping blades.

### SUMMARY

In this disclosure, an arrangement may be provided for mounting a chopping blade on a chopping drum of a forage harvester, which allows relatively fast installation and nevertheless offers a possibility for adjusting the mounting position of a chopping blade, whether to adjust the position of a new chopping blade to the position of already worn chopping blades or to improve the air scoop effect of worn chopping blades.

In one embodiment of the present disclosure, an open or closed chopping drum for a forage harvester is equipped with a number of blade holders distributed around the periphery (and optionally over the width) of the chopping drum, on each of which blade holders a respective chopping blade can selectively be fixed in one of at least two different positions specified by form-fitting means.

The present disclosure is therefore differentiated from the known solutions in that at least two different positions of the chopping blade on the blade holder can be specified by form-fitting means. In this manner, a chopping blade can be brought into a suitable but prescribed position depending on whether it is new or already worn down. In particular, new chopping blades can be fixed in a position lying further inward than that of already partially worn chopping blades, which can be fixed in a radially further outward position. There is accordingly the possibility of fixing the chopping blade quickly and nevertheless in a suitable position. Of course, more than two different positions, e.g., three or four or even more, can also be specified by the form-fitting means.

The form-fitting means can include, for example, a recess designed as a bore in the blade holder or in the chopping blade, into which a protruding element, coupled permanently or detachably to the chopping blade or the blade holder, can be introduced, the element being in particular a removable locating pin. The form-fitting position specification of the chopping blade is accordingly enabled by the use of locating pins and one or more pairs of matching bores.

The locating pins are made from a suitable material, such as plastic, and their dimensions are such that they can hold the blade stable during installation so that a displacement of the chopping blade does not take place during tightening of the fastening bolts, but the locating pins can shear off in case of a foreign body event or some other overload and thus enable yielding of the chopping blades in order to provide protection against overload.

Slots or elongated holes in the chopping blade, through which the mounting screws extend, are used for this purpose. The use of elongated holes rather than slots open to the rear also prevents the entry and deposition of dirt and thus also reduces the cleaning effort for the blade holder and the cover plates. In order to further reduce dirt deposits, the elongated holes can be permanently covered by the blade cusps and cover plates after installation. In addition, the contact surfaces between the cusps and the blades as well as between the blades and the cover plate may be machined flat in order to also suppress lateral intrusion of dirt.

A form-fitting means is present on each of the two lateral ends of the chopping blade, although it is also conceivable to attach only one form-fitting means in the center of the chopping blade. A fixation of the chopping blade against rotation in its own plane can be achieved by a noncircular shape of the form-fitting means.

A suitable chopping blade, which can selectively be fixed in one of at least two different positions specified by form-fitting means on a chopping drum, is characterized in that the chopping blade has on each side at least two bores spaced apart from one another in a direction transverse to the cutting edge of the chopping blade, into which bores an element can be inserted that can additionally be brought into engagement with a bore in a blade holder of the chopping drum.

### BRIEF DESCRIPTION OF THE DRAWINGS

The above-mentioned aspects of the present disclosure and the manner of obtaining them will become more apparent and the disclosure itself will be better understood by reference to the following description of the embodiments of the disclosure, taken in conjunction with the accompanying drawing, wherein:

FIG. 1 is a schematic side view of a forage harvester;

FIG. 2 is a perspective view of a chopping drum of the forage harvester of FIG. 1; and

FIG. 3 is a schematic representation of mounting possibilities for chopping blades on the chopping drum of FIG. 2.

### DETAILED DESCRIPTION

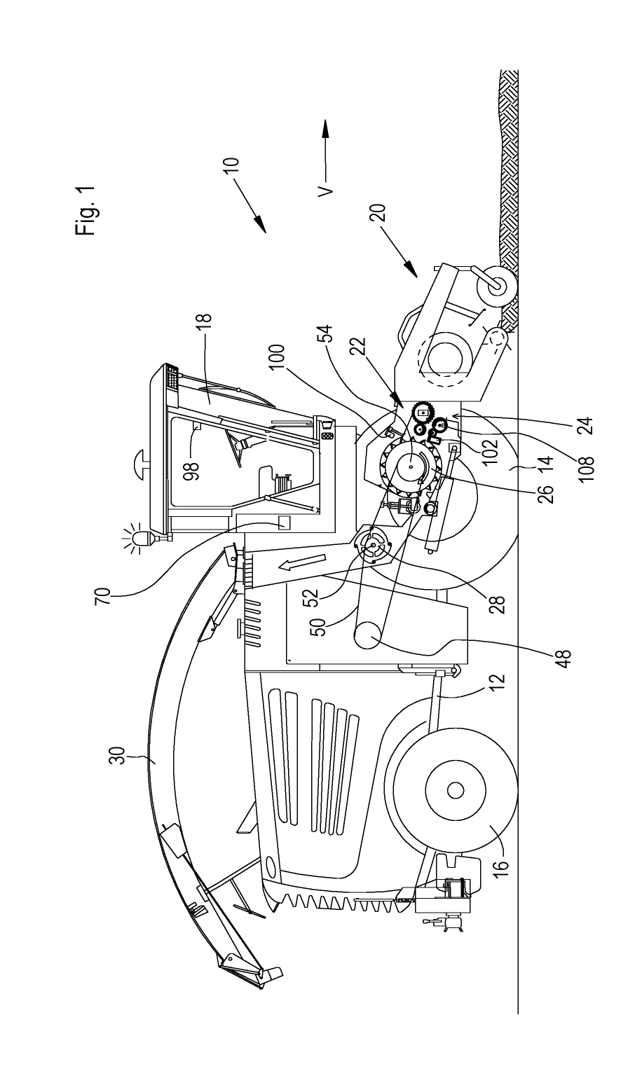

FIG. 1 presents a self-propelled forage harvester 10 in a schematic side view. The forage harvester 10 is constructed on a frame 12, which is supported by driven front wheels 14 and steerable rear wheels 16. The forage harvester 10 is operated from a driver's cab 18, from which a harvesting header 20 in the form of a pickup can be seen. Crop such as grass or the like picked up from the ground means of the harvesting header 20 is fed via an intake conveyor 22, having pre-compression rollers arranged inside an intake housing 24 at the front end of the forage harvester 10, to a chopping drum 26, which is arranged underneath the driver's cab 18. In cooperation with a counter blade 102, the chopping drum 26 chops the crop into small pieces and transfers it to a conveying device 28. Via an ejection chute 30, rotatable about an approximately vertical axis and having an adjustable inclination, the material leaves the harvesting machine 10 to a transport vehicle driving alongside. Directional indications such as to the side, below and above in the text below relate to the front direction V of the harvesting machine 10, which runs to the right in FIG. 1.

The chopping drum 26 is driven proceeding from a belt sheave 48, which is connected via an angle gear to an internal combustion engine (not shown) via a drive belt 50, a belt sheave 54 for driving the chopping drum 26 and a belt sheave 52 for driving the conveying device 28. A sharpening device 100 is used for sharpening the chopping blades of the chopping drum 26. In addition, a metal detector 108 is provided in the lower front pre-compression roller, which is used for a fast stop of the intake conveyor 22 if necessary, as well as a user input device 98 coupled to a controller 70 in the driver's cab 18.

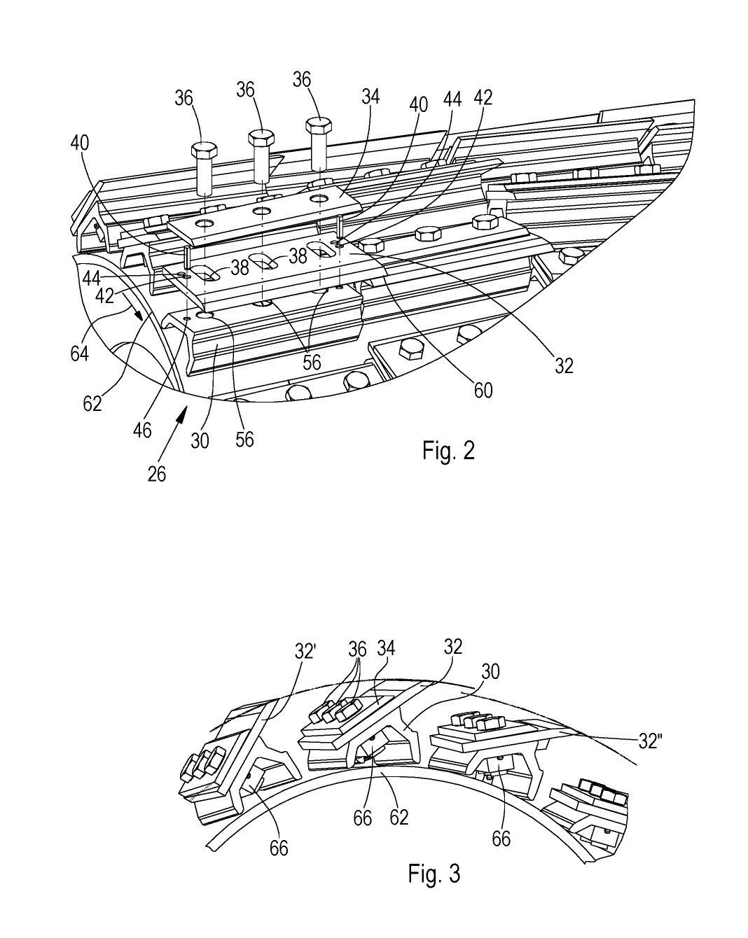

FIG. 2 shows a perspective view of the upper region of the chopping drum 26, which rotates in the direction of the arrow 64 while in operation. The chopping drum 26 includes a closed drum outer surface 62, which is connected via end face walls and axle stubs, not shown, to the belt sheave 54 and bearing assemblies that support it on the frame 12. Across the circumference and the width of the of the drum surface 62, blade holders 30 are distributed. Each of the blade holders 30 have a forward-facing limb welded to the drum surface 62 and a reverse-facing limb welded to the drum surface 62, and an external fastening surface extending between the limbs, and provided with three bores or threads 56. The individual chopping blades 32 each have a forward cutting edge 60 and a body having three elongated holes 38. Cover plates 34, which are provided with three bores, are arranged above the chopping blade 32.

The chopping blades 28 are fastened to the blade holders 30 by three bolts 36, each of which extends in the fastened state through one of the bores in the cover plate 34, an elongated hole 38 of the chopping blade 32 and a bore 56 in the blade holder 30, and the thread of which cooperates with a thread in a crossbar 66 (see FIG. 3) having threaded holes and which is arranged in the cavity between the limbs of the blade holder 30.

The blade holders 30 are each provided with a bore 46 at the two lateral ends thereof, while the bodies of the chopping blades 32 are provided at the lateral ends thereof with two first bores 42 and two second bores 44. Locating pins 40 fit into the bores 42-46.

The task of the locating pins 40 is to form-fittingly align the chopping blades 32 during installation on the chopping drum 26. If new chopping blades 32 are mounted, a locating pin 40 is inserted into the respective rear bores 42 of the blade holder 30. During mounting of the chopping blade 32, the locating pin 40 necessarily also moves into the bores 46 of the chopping blade 32, insofar as the locking pin 40 is not already inserted into the bore 46 of the chopping blade 32. Thus, a reinstallation and alignment of the chopping blades 32 in the correct position is achieved when the chopping blades 32 are new, as illustrated on the right-hand side in FIG. 3 on the basis of the chopping blade 32. If the chopping blades 32 wear down, their envelope circle diameter becomes smaller, as shown on the right-hand side in FIG. 3 on the basis of the chopping blade 32″. In this case, a realignment can be carried out to restore a larger envelope circle diameter for improving the air scoop effect of the chopping blades 32, during which operation (after removing the bolts 36 and removing the chopping blade 32) the locating pins 40 are inserted into the front bores 44 of the blade holder 30. The subsequent installation steps are as described above. Thereby the situation as shown on the left-hand side in FIG. 3 on the basis of the chopping blade 32′ is obtained. The (partially worn) chopping blades 32′ are accordingly displaced radially outward (and approximately tangentially to the rotational direction of the chopping drum 26) by constant distances.

In case of an overload, the locating pins 40 produced from plastic can yield (shear off) and the chopping blades 32 can escape to the rear along the elongated holes 38. The cover plates 34 close off the elongated holes 38 on all sides and prevent the intrusion of contaminants.

According to all of this, the bores 42-46 and the locating pins 40 accordingly implement a form-fitting connection between the blade holders 30 and the chopping blades 32 for preliminary installation of the chopping blades 32 and make it possible to preselect two different positions for the chopping blades 32. In addition to the above-mentioned realignment of the chopping blades 32, a modification of the chopping blades 32 from those shown above to angled chopping blades (not shown), for example, can be achieved in a fast and simple manner when the type of plant material to be harvested is changed, e.g., from grass to corn. The blade modifications as described can be carried out in relatively short time due to the described pre-alignment of the chopping blades 32 by the form-fitting connection. If one of the chopping blades 32 must be replaced, the locating pin 40 can be eliminated and the new chopping blade 32 can be introduced in an infinitely variable manner into a position corresponding to the degree of wear of the other cutting blades 32 and fastened there.

It should be remarked that, in place of two bores 42, 44 on the blade holder 30, it is possible to form only one bore there and instead apply two bores to the chopping blade 32 in order to allow the different positions of the chopping blade 32. More than two positions can also be selectable in both variants.

While embodiments incorporating the principles of the present disclosure have been described hereinabove, the present disclosure is not limited to the described embodiments. Instead, this application is intended to cover any variations, uses, or adaptations of the disclosure using its general principles. Further, this application is intended to cover such departures from the present disclosure as come within known or customary practice in the art to which this disclosure pertains and which fall within the limits of the appended claims.

1. A chopping drum for a forage harvester, comprising:
a plurality of blade holders distributed around the periphery of the chopping drum;
a plurality of chopping blades;
wherein, each of the chopping blades is selectively coupled to at least one blade holder in one of at least two different positions specified by a form-fitting means.

2. The chopping drum of claim 1, wherein the form-fitting means comprises a recess or bore defined in the blade holder or in the chopping blade into which a protruding element coupled to the chopping blade or the blade holder is inserted.

3. The chopping drum of claim 2, wherein the protruding element comprises a removable locating pin.

4. The chopping drum of claim 3, wherein the locating pin comprises a material that yields in case of an overload.

5. The chopping drum of claim 1, wherein the chopping blade is coupled by at least two bolts to the blade holder.

6. The chopping drum of claim 5, wherein the at least two bolts extend through elongated holes or slots in the chopping blade.

7. The chopping drum of claim 6, further comprising a cover plate for covering the elongated holes, the cover plate being in contact with an outer side of the heads of the at least two bolts.

8. The chopping drum of claim 1, wherein a surface of the blade holder contacting the chopping blade is oriented approximately tangentially to the chopping drum.

9. The chopping drum of claim 1, wherein a respective form-fitting means is present on each lateral end of the chopping blade.

10. A forage harvester, comprising:
a frame;
a plurality of wheels for supporting the frame; and
a chopping drum including a plurality of blade holders distributed around the periphery of the chopping drum and a plurality of chopping blades;
wherein, each of the chopping blades is selectively coupled to at least one blade holder in one of at least two different positions specified by a form-fitting means.

11. The forage harvester of claim 10, wherein the form-fitting means comprises a recess or bore defined in the blade holder or in the chopping blade into which a protruding element coupled to the chopping blade or the blade holder is inserted.

12. The forage harvester of claim 11, wherein the protruding element comprises a removable locating pin.

13. The forage harvester of claim 12, wherein the locating pin comprises a material that yields in case of an overload.

14. The forage harvester of claim 10, wherein the chopping blade is coupled by at least two bolts to the blade holder.

15. The forage harvester of claim 14, wherein the at least two bolts extend through elongated holes or slots in the chopping blade.

16. The forage harvester of claim 15, further comprising a cover plate for covering the elongated holes, the cover plate being in contact with an outer side of the heads of the at least two bolts.

17. The forage harvester of claim 10, wherein a surface of the blade holder contacting the chopping blade is oriented approximately tangentially to the chopping drum.

18. The forage harvester of claim 10, wherein a respective form-fitting means is present on each lateral end of the chopping blade.

19. A chopping blade of a forage harvester, comprising:
a body having a cutting edge, the body configured to be selectively coupled in one of at least two different positions via a form-fitting means to a chopping drum;
at least two bores defined on each side of the body spaced apart from one another in a direction transverse to the cutting edge, and
a protruding element for being inserted into the at least two bores and configured to be engaged with a corresponding bore defined in a blade holder of the chopping drum.

20. The chopping blade of claim 19, wherein the protruding element comprises a removable locating pin.
